(19) United States
(12) Patent Application Publication
(10) Pub. No.: US 2013/0295902 A1
(43) Pub. Date: Nov. 7, 2013

(54) Method And Apparatus For Remotely Managing Devices Utilizing Request-Response Protocols

(71) Applicant: Nokia Corporation, (US)

(72) Inventors: Simon Justen, Ulm (DE); Teemu Laine, Sauvo (FI); John Mathews, Espoo (FI); Arto Mutanen, Tervakoski (FI); Paul Oommen, Sunnyvale, CA (US); Lars Reinbold, Ulm (DE); Esa A. Saarinen, Turku (FI); Jonne Saarinen, Espoo (FI); Sebastian Seitz, Ulm (DE); Ralf Engels, Dornstadt (DE)

(21) Appl. No.: 13/855,228

(22) Filed: Apr. 2, 2013

Related U.S. Application Data
(60) Provisional application No. 61/620,747, filed on Apr. 5, 2012.

(51) Int. Cl. H04W 8/22

(52) U.S. Cl. CPC H04W 8/22
USPC 455/418

(57) ABSTRACT

An approach is provided for remotely managing mobile devices utilizing one or more request-response protocols. The web client determines a management operation for a device, a resource associated with the management operations, or a combination thereof. The web client processes and/or facilitates a processing of the management operations, the resources, or a combination thereof to determine a transaction command for completing the management operations, wherein the transaction commands are realized via a request-response protocol. The device management platform processes and/or facilitates a processing of a transaction command from a device to determine a resource associated with a management operation. The device management platform causes a generation of a resource associated with a management operation for the device based on the transaction commands. The device management platform causes a transmission of address information associated with the resources, the other resources, or a combination thereof via a request-response protocol.

### BACKGROUND

Service providers and device manufacturers (e.g., wireless, cellular, etc.) are continually challenged to deliver value and convenience to consumers by, for example, providing compelling network services. One area of interest has been the development of mechanisms for the remote management of mobile devices (e.g., create, read, update, and delete (CRUD) operations). Existing mechanisms such as Open Mobile Alliance Device Management (OMA DM) 1.2/1.3 enable some device management functionalities using Synchronization Markup Language (SyncML). However, OMA DM 1.2/1.3 requires implementing the SyncML protocol stack and device management (DM) extensions as well as involving multiple roundtrips to complete a management task. Further, SyncML is too heavy for sensor and other resource constrained devices, which require communication with smart phones for many consumer applications. Accordingly, service providers and device manufactures face significant technical challenges in providing a truly web based protocol for remotely managing mobile devices based on widely adopted standards and software architecture.

### Some Example Embodiments

Therefore, there is a need for an approach for remotely managing mobile devices utilizing one or more request-response protocols.

According to one embodiment, a method comprises determining one or more management operations for at least one device, one or more resources associated with the one or more management operations, or a combination thereof. The method also comprises processing and/or facilitating a processing of the one or more management operations, the one or more resources, or a combination thereof to determine one or more transaction commands for completing the one or more management operations, wherein the one or more transaction commands are realized, at least in part, via one or more request-response protocols.

According to another embodiment, an apparatus comprises at least one processor, and at least one memory including computer program code for one or more computer programs, the at least one memory and the computer program code configured to, with the at least one processor, cause, at least in part, the apparatus to determine one or more management operations for at least one device, one or more resources associated with the one or more management operations, or a combination thereof. The apparatus is also caused to process and/or facilitate a processing of the one or more management operations, the one or more resources, or a combination thereof to determine one or more transaction commands for completing the one or more management operations, wherein the one or more transaction commands are realized, at least in part, via one or more request-response protocols.

According to another embodiment, a computer-readable storage medium carries one or more sequences of one or more instructions which, when executed by one or more processors, cause, at least in part, an apparatus to determine one or more management operations for at least one device, one or more resources associated with the one or more management operations, or a combination thereof. The apparatus is also caused to process and/or facilitate a processing of the one or more management operations, the one or more resources, or a combination thereof to determine one or more transaction commands for completing the one or more management operations, wherein the one or more transaction commands are realized, at least in part, via one or more request-response protocols.

According to another embodiment, an apparatus comprises means for determining one or more management operations for at least one device, one or more resources associated with the one or more management operations, or a combination thereof. The apparatus also comprises means for processing and/or facilitating a processing of the one or more management operations, the one or more resources, or a combination thereof to determine one or more transaction commands for completing the one or more management operations, wherein the one or more transaction commands are realized, at least in part, via one or more request-response protocols.

According to one embodiment, a method comprises processing and/or facilitating a processing of one or more transaction commands from at least one device to determine one or more resources associated with one or more management operations. The method also comprises causing, at least in part, a generation of one or more other resources associated with one or more management operations for the at least one device based, at least in part, on one or more transaction commands. The method further comprises causing, at least in part, a transmission of address information associated with the one or more resources, the one or more other resources, or a combination thereof via one or more request-response protocols.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of one or more transaction commands from at least one device to determine one or more resources associated with one or more management operations. The apparatus is also caused to cause, at least in part, a generation of one or more other resources associated with one or more management operations for the at least one device based, at least in part, on one or more transaction commands. The apparatus is further caused to cause, at least in part, a transmission of address information associated with the one or more resources, the one or more other resources, or a combination thereof via one or more request-response protocols.

According to another embodiment, a computer-readable storage medium carries one or more sequences of one or more instructions which, when executed by one or more processors, cause, at least in part, an apparatus to process and/or facilitate a processing of one or more transaction commands from at least one device to determine one or more resources associated with one or more management operations. The apparatus is also caused to cause, at least in part, a generation of one or more other resources associated with one or more management operations for the at least one device based, at least in part, on one or more transaction commands. The apparatus is further caused to cause, at least in part, a transmission of address information associated with the one or more resources, the one or more other resources, or a combination thereof via one or more request-response protocols.

According to another embodiment, an apparatus comprises means for processing and/or facilitating a processing of one or more transaction commands from at least one device to determine one or more resources associated with one or more management operations. The apparatus also comprises means for causing, at least in part, a generation of one or more other resources associated with one or more management operations for the at least one device based, at least in part, on one or more transaction commands. The apparatus further comprises means for causing, at least in part, a transmission of address information associated with the one or more resources, the one or more other resources, or a combination thereof via one or more request-response protocols.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of remotely managing mobile devices utilizing one or more request-response protocols, according to one embodiment;

FIG. 2A is a diagram of the components of a web client, according to one embodiment;

FIG. 2B is a diagram of the components of a device management platform, according to one embodiment;

FIG. 3 is a flowchart of the client side process for remotely managing mobile devices utilizing one or more request-response protocols, according to one embodiment;

FIG. 4 is a flowchart of the server side process for remotely managing mobile devices utilizing one or more request-response protocols, according to one embodiment;

FIGS. 5A-5C are ladder diagrams that illustrate a sequence of messages and processes for remotely managing mobile devices utilizing one or more request-response protocols, according to one embodiment;

FIG. 6 is a diagram of user interfaces utilized in the processes of FIGS. 3 and 4, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for remotely managing mobile devices utilizing one or more request-response protocols are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “resource” generally refers to both “management data” and “resources.” “Management data” can refer to any one of the following: configuration settings required for the mobile device to seamlessly operate over various networks; application settings; software or firmware; device information and capabilities; hardware capabilities, configuration and control information for hardware attached to the mobile device; logs, measurements, diagnostic data; and a catalog providing information on updatable components (e.g., software or firmware, menus, etc.). A “resource” can refer to a catalog providing information on resources (e.g., the Uniform Resource Locator (URL) of the location where the resources are available as well as different versions modified since the specified date). The catalog can also contain information such as information about a source—Target software (SW) (e.g., in case of an update); how much space is needed for installation; whether the target SW is bigger than the source SW; release notes; overall download size; hash to validate the download; priority, etc. The catalogue can be in Extensible Markup Language (XML) or any standard form supported by the device client and may be in a compressed form, using any compression scheme supported by the device client (e.g., as indicated in the Hypertext Transfer Protocol (HTTP) header). A “resource” can also refer to software components and/or firmware in binary form. Further, a “resource” can refer to configuration data; and settings (e.g., policy configurations, account settings, connectivity settings) and the configuration data can be represented in any supported form. For example, it can be a plain XML object or an OMA DM object following the OMA DM tree and descriptions standard. In addition, a “resource” can also refer to one or more single parameter values (e.g., a value of a single parameter in the connectivity settings).

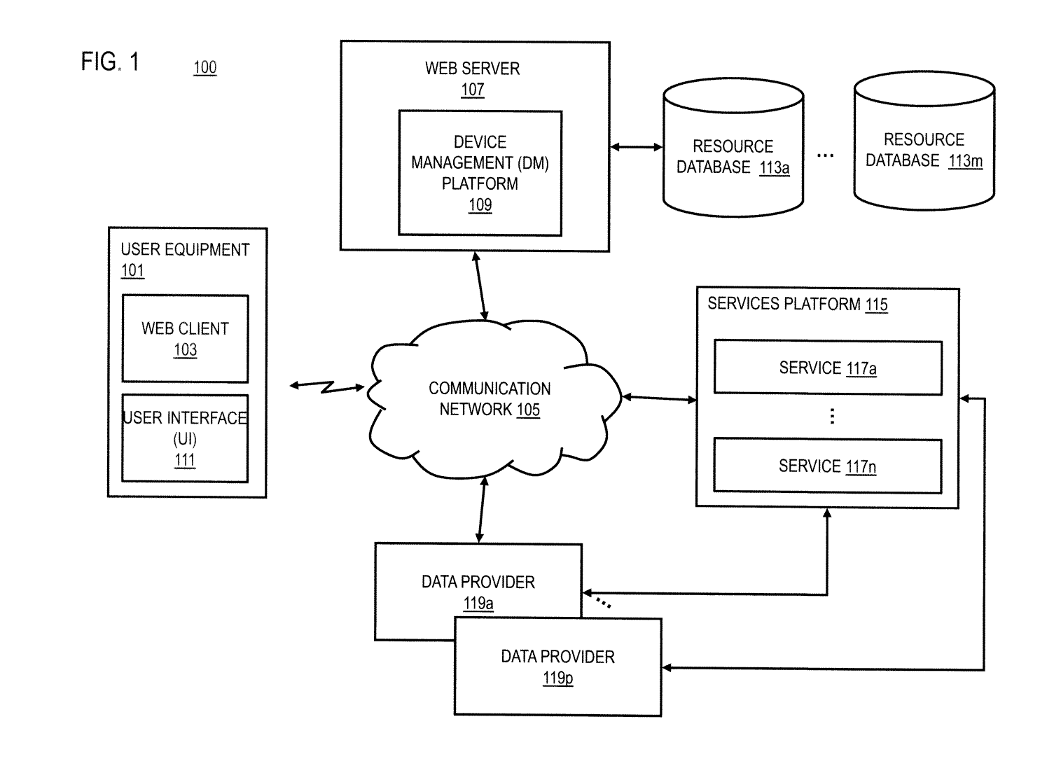

FIG. 1 is a diagram of a system capable of remotely managing mobile devices utilizing one or more request-response protocols, according to one embodiment. As previously discussed, one area of interest among service providers and device manufacturers has been the development of mechanisms for the remote management of mobile devices (e.g., mobile phones and/or tablets). More specifically, remote management involves developing mechanisms to enable a mobile device to request management data and/or resources from a network server, to enable a server to respond with status information and associated management data or results in response to a request from the device as well as to create and update management data in mobile devices, and to report the status of a complete management task in a device. Existing mechanisms such as OMA DM 1.2/1.3 enable some device management functionalities based on SyncML protocol for representing the management commands exchanged between a device and a management server. However, OMA DM 1.2/1.3 requires implementing the SyncML protocol stack and DM extensions and additional processing in the device and the server for performing remote management CRUD operations. Moreover, a typical DM 1.2/1.3 session involves multiple roundtrips to complete a management task (e.g., software update). In addition, SyncML requires a unique command set for exchanging and manipulating management data between the client and the server. Further, SyncML is too heavy for sensor and other resource constrained devices which require communication with other mobile devices (e.g., smart phones) for many consumer applications.

To address this problem, a system 100 of FIG. 1 introduces the capability to remotely manage mobile devices utilizing one or more request-response protocols. In one embodiment, the system 100, on the client side (e.g., in a client-initiated management operation), first determines one or more management operations for at least one device (e.g., a mobile phone or tablet), one or more resources associated with the one or more management operations (e.g., management data and/or one or more resources), or a combination thereof. By way of example, the one or more management operations may include such scenarios as updating software and firmware in a device; updating configuration settings; automatic and manual updates; server and client-initiated updates and management operations; retrieving management data from one or more devices; and provisioning a wireless device purchased in a retail market with a consumer selected service provider as opposed to provisioning the device through the operator channel or in-store provisioning in a closed ecosystem.

The system 100 then processes the one or more management operations (e.g., updating firmware in the mobile device), the one or more resources (e.g., firmware in binary form), or a combination thereof to determine one or more transaction commands for completing the one or more management operations, wherein the one or more transaction commands are realized, at least in part, via one or more request-response protocols (e.g., HTTP). The one or more transaction commands include one or more of the nine methods indicating a desired action to be performed on the identified resource (e.g., HEAD, GET, POST, PUT, DELETE, TRACE, OPTIONS, CONNECT, and PATCH). More specifically, in one embodiment, the system 100 performs a HTTP GET on a resource Uniform Resource Identifier (URI) and later uses the POST method to report the results of a management request or to provide management data to at least one server. In addition, the system 100 may also send one or more Alerts or Notifications to the server using the POST method when one or more events occur in at least one device. While a multitude of request-response protocols are available, the various embodiments of the present invention disclosed herein use HTTP for the sake of explanation. In particular, using HTTP methods is advantageous because it simplifies the end to end protocol.

In one embodiment, the system 100 next causes, at least in part, an identification of the one or more management operations, the one or more resources, or a combination thereof in the one or more transaction commands (e.g., a GET command) using one or more resource identifiers, wherein the one or more resource identifiers include, at least in part, one or more URIs. More specifically, the one or more resources (e.g., one or more packages containing one or more files) that are managed in one or more devices are identified by an ID (e.g., <Id> 2241-e27a-477f-b105</Id>) and the one or more files inside of the one the one or more packages are uniquely identified through a URI. Further, the resource itself (e.g., management data and/or one or more resources) can be represented in many ways. For example, one or more resources such as software/firmware can be represented in binary form and configuration/management data can be represented as XML or JavaScript Object Notation (JSON). Similarly, management data can be represented as Management Objects (MOs) or Application Characteristics (ACs) following the DM 1.X representation protocol or OMA client provisioning (OMA CP).

In certain embodiments, the system 100 then causes, at least in part, an encoding of device capability information, device contextual information, network information, or a combination thereof in the one or more transaction commands, wherein the address information (e.g., a URI) is determined based, at least in part, on the device capability information, the contextual information, the network information, or a combination thereof. More specifically, in an example use case involving the GET command, the URI includes encoded parameters to uniquely identify the requested resource (e.g., firmware) for the specific device (e.g., a mobile phone) by the entity processing the request (e.g., a DM server). By way of example, for a client-initiated request, a resource URI may have the following generic form: “<RESOURCE URI>? <sn>&<pc>&<sv>&<id>&<init>&<sim_mnc>&<sim_mcc>&<nw_mnc>&<nw_mcc>&<APN>”, wherein the encoded parameters respectively specify the Serial Number of the Device, the Product Code, language (e.g., Swedish), the ID used in reports, Request Initiated, Mobile network code of Subscriber Identity Module (SIM) for zero rating, Mobile country code of SIM for zero rating, Mobile network code of network for zero rating, mobile country code of network for zero rating, and Access Point Name (APN). In certain embodiments, the resource URI may also include a Service Provider Name (SPN). In addition, HTTP header fields in the request (e.g., standard fields or non-standard fields) can be used to provide required parameters for one or more management operations. For example, including the current version of a resource in the device allows the server to determine if there is a newer version of the resource available.

In one embodiment, the system 100 next causes, at least in part, a transmission of the one or more transaction commands (e.g., a GET command) to at least one server (e.g., a DM server) according to one or more request-response protocols (e.g., HTTP). In one example use case, the at least one server responds to the request with a standard HTTP response, which may include a message body. In one embodiment, the system 100 then determines address information (e.g., a URI) for the one or more management operations, the one or more resources, or a combination thereof in response to the transmission of the one or more transaction commands. More specifically, if at least one device requests a resource and the requested resource is available, at least one server (e.g., a DM server) includes the URI to the requested resource in the HTTP header or the server includes the requested resource in the message body following the HTTP standard. However, if the system 100 determines the resource is unavailable, then the at least one server responds with a status code (e.g., “404 Not Found”) and optionally provides more information in the HTTP header and/or message body.

In certain embodiments, the system 100 on the client side (e.g., in a server-initiated management operation) processes the address information (e.g., a Target URI) to determine one or more resource hierarchies associated with the at least one device and then causes, at least in part, a selection of the one or more resources from the one or more resource hierarchies based, at least in part, on the device capability information, the device contextual information, the network information, or a combination thereof. In particular, in an example use case where the at least one server (e.g., a DM server) uses the POST or PUT method to create new management data or to update existing management data in a device (e.g., a mobile device), the client associated with the at least one device receives and processes the request including a Target URI, which is the URI identifying the management data in the device (e.g., the location of the management data organized as a hierarchical tree). As a result, the client should be able to access the management data and perform the requested management operation. More specifically, if the requested management data does not exist in the device, the client should be able to create it, and if the management data does exist in the device, the client should be able to update it. Further, when the server is using the POST method, if the server did not specify the exact location of the resource in the device, the client should be able to resolve the location and create and/or update it for the domain or management authority represented by the server. For example, if settings are implemented as a hierarchical management tree in the device, an operator server may not know the exact URI of the resource in the hierarchical tree of the device. Therefore, the device client should be able to update the operator settings accordingly.

In one embodiment, the system 100, on the server side (e.g., in a client-initiated management operation), first processes the one or more transaction commands (e.g., a GET command) from at least one device (e.g., a mobile phone) to determine one or more resources (e.g., firmware) associated with the one or more management operations (e.g., updating software and firmware). The system 100 then causes, at least in part, a transmission of the address information (e.g., a URI) associated with the one or more resources via one or more request-response protocols (e.g., HTTP). As previously discussed, if the system 100 determines that the resource requested by the at least one device is available, then the system 100 includes the URI to the requested resource in the HTTP header or includes the requested resource in the message body following the HTTP standard. By way of example, the response of the system 100 may take the following form:

Response: Catalog is available

| | |
|---|---|
| Descrip- | Newer version of catalog is available, compared to the time- |
| tion | stamp provided in the request header “If-Modified-Since” |
| | In addition to catalog modification, the catalog version will be |
| | renewed if any of the following are also modified. |
| | X-PollingFreq |
| | X-ReportingUrl |
| Status: | 302 Found |
| Body: | |
| Http | Location: <URL of the catalog file in CDN> |
| Header | Last-Modified: <timestamp of catalog in server> |
| | X-Zero-Rating: true |
| | X-Max-Size: 88239823 (value in kb) |
| | X-PollingFreq: 1 (value in days) |
| | X-ReportingUrl: https://sunbeam.nokia.com/fw/delta/report |
| | Refer Section 3.2 for file download. |

In contrast, if the system 100 determines that the resource is unavailable, the responses of the system 100 may take the following forms:

Response: Case 1 - Bad Request

| | |
|---|---|
| Descrip- | If mandatory values are missing or values are invalid. |
| tion | |
| Status: | 400 Bad Request |
| Body: | <error description> |
| Http | X-PollingFreq: 1 (value in days) (default value only) |
| Header | X-ReportingUrl: https://sunbeam.nokia.com/fw/delta/report |

Response: Case 2 - Not Modified

| | |
|---|---|
| Descrip- | Newer version of catalog is not available, when compared |
| tion | to the timestamp provided in the request header |
| | “If-Modified-Since”. |
| Status: | 304 Not Modified |
| Body: | |
| Http | |
| Header | |

Response: Case 3 - Catalog is not available

| | |
|---|---|
| Descrip- | Catalog is not available for the given query parameters |
| tion | |
| Status: | 404 Not Found |
| Body: | |
| Http | X-PollingFreq: 1 (value in days) (default value only) |
| Header | X-ReportingUrl: https://sunbeam.nokia.com/fw/delta/report |

In certain embodiments, the system 100 processes the one or more transaction commands (e.g., a POST command) to determine the device capability information, the device contextual information, the network information, or a combination thereof. In one example use case, at least one device uses the POST method to report the results of a management request or to provide management data to at least one server. The report should include an appropriate status code and additional information related to the processed management request. Further, the report can be in an XML form or in the form of any well defined metadata. As previously discussed, standard HTTP header fields can be used to provide information on the content type, compression scheme, etc. and/or the HTTP header may include non-standard fields for specific management needs.

In one embodiment, the system 100 causes, at least in part, a transmission of one or more responses to the at least one device (e.g., a mobile phone) based on the one or more transaction commands (e.g., a POST command), the device capability information, the device contextual information, the network information, or combination thereof. By way of example, the device can send the one or more results reports asynchronously in a new session following the processing of a management request. Consequently, at least one server may respond to the device with the status code “200 OK” after determining the results report from the device. In one embodiment, if the device does not receive the status code “200 OK,” then the device will send the report until the server receives it.

In an exemplary embodiment, the at least one device sends one or more results reports for each management request. For example, the at least one device can generate the following four reports for a firmware update: (1) After discovery (time taken to download the catalog); (2) After download (the status is “Download OK,” “Download failed,” “File corrupt during download,” “Resume download was needed,” etc.); (3) After user acceptance (installation has started); and (4) After installation (installation time, if at least one server does not receive this report, it means the device is broken). In one embodiment, the system 100 then causes, at least in part, one or more actions, one or more optimizations, or a combination thereof based, at least in part, on the one or more transaction commands (e.g., a POST command), the device capability information, the device contextual information (e.g., one or more results reports), the network information, or a combination thereof. More specifically, the system 100 can take one or more appropriate actions if the system 100 determines from the one or more results reports that there was a failure at any stage of the one or more management operations.

In certain embodiments, the system 100 may also process the device capability information, the device contextual information, the network information, or a combination thereof to determine a status of the at least one device (e.g., a mobile phone). More specifically, in an example use case involving a client-initiated management operation, the at least one device uses the POST or PUT method to send management data to at least one server. For example, the device can send an entire management object to the server. The system 100 can then use the management object for diagnostic purposes to ensure that the configuration of the device is correct. Based on the results of the diagnostic evaluation, the system 100 can cause, at least in part, a transmission of the address information (e.g., a URI) based, at least in part, on the status of the device. By way of example, the system 100 can provide the device with the URI to the correct configuration and the device can retrieve the correct configuration and store it in the Client URI, which can also be the location of the configuration object in a hierarchical management tree.

In one embodiment, the system 100 causes, at least in part, a generation of one or more other resources associated with one or more management operations for the at least one device based, at least in part, on the one or more transaction commands (e.g., a POST command). More specifically, in an example use case involving a server-initiated management operation, at least one server uses the POST or PUT method to create new management data or to update existing management data in at least one device (e.g., a mobile phone). As previously discussed, the system 100 then processes the device capability information, the device contextual information, the network information, or a combination thereof to determine one or more resource hierarchies associated with the device. By way of example, the system 100 determines the Target URI, which is the URI identifying the management data of the device. For example, the URI can be the location of the management data organized as a hierarchical tree. In one embodiment, the system 100 then causes, at least in part, a transmission of the address information (e.g., the URI) based, at least in part, on the one or more resource hierarchies. Again, as previously discussed, once the client associated with the device receives the request and processes the request, the client should be able to access the management data and perform the requested management operation.

As shown in FIG. 1, the system 100 comprises a user equipment (UE) 101 (e.g., a mobile phone) containing a web client 103 (e.g., a web browser, a DM client, or a combination thereof) having connectivity to a web server 107 containing a Device Management (DM) platform 109 via a communication network 105. To support the client-initiated management operations, the web client 103 may interact with a user interface (UI) 111 for controlling or presenting various portions of the client-initiated management process. The web server 107 is also connected to one or more resource databases 113a-113m (also collectively referred to as resource databases 113). In one embodiment, the resource databases 113 may contain management data and/or one or more resources. Both the device management platform 109 and the resource databases 113 may exist in whole or in part within the web server 107, or independently.

In one embodiment, the source of the one or more resources (e.g., management data) may be the services platform 115, the one or more services 117a-117n (also collectively referred to as services 117) of the services platform 115, the one or more data providers 119a-119p (also collectively referred to as data providers 119), and/or other data services available over the communication network 105. For example, a service 117 may obtain software or firmware from a data provider 119 to deliver the obtained data (e.g., management data) to the device management platform 109, the web client 103, or a combination thereof.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, from the client side perspective (e.g., in a web client 103-initiated management operation), the web client 103 first determines one or more management operations for the UE 101 (e.g., a mobile phone or tablet), one or more resources associated with the one or more management operations (e.g., management data and/or one or more resources), or a combination thereof. The web client 103 then processes the one or more management operations (e.g., updating firmware in the UE 101), the one or more resources (e.g., firmware in binary form), or a combination thereof to determine one or more transaction commands for completing the one or more management operations, wherein the one or more transaction commands are realized, at least in part, via one or more request-response protocols (e.g., HTTP). More specifically, in one embodiment, the web client 103 performs a HTTP GET on a resource URI and later uses the POST method to report the results of a management request or to provide management data to the device management platform 109. In addition, the web client 103 may also send one or more Alerts or Notifications to the device management platform 109 using the POST method when one or more events occur in the UE 101.

In one embodiment, the web client 103 next causes, at least in part, an identification of the one or more management operations, the one or more resources, or a combination thereof in the one or more transaction commands (e.g., a GET command) using one or more resource identifiers, wherein the one or more resource identifiers include, at least in part, one or more URIs. More specifically, the one or more resources that are managed in one or more devices (e.g., a UE 101) are uniquely identified through a URI. In certain embodiments, the web client 103 then causes, at least in part, an encoding of the device capability information, the device contextual information, network information (e.g., the communication network 105), or a combination thereof in the one or more transaction commands, wherein the address information (e.g., a URI) is determined based, at least in part, on the device capability information, the device contextual information, the network information, or a combination thereof. More specifically, in an example use case involving the GET command, the URI includes encoded parameters to uniquely identify the requested resource (e.g., firmware) for the specific device (e.g., the UE 101) by the entity processing the request (e.g., the device management platform 109). In addition, HTTP header fields in the request (e.g., standard fields or non-standard fields) can be used to provide required parameters for one or more management operations. For example, including the current version of a resource in the UE 101 allows the device platform 109 to determine if there is a newer version of the resource available (e.g., from the resource databases 113, the services platform 115, the services 117, the data providers 119, or a combination thereof).

In one embodiment, the web client 103 next causes, at least in part, a transmission of the one or more transaction commands (e.g., a GET command) to the device management platform 109 according to one or more request-response protocols (e.g., HTTP). The device management platform 109 responds to the request with a standard HTTP response, which may include a message body. In one embodiment, the web client 103 then determines address information (e.g., a URI) for the one or more management operations, the one or more resources, or a combination thereof in response to the transmission of the one or more transaction commands. More specifically, if web client 103 of the UE 101 requests a resource and the requested resource is available, the device management platform 109 includes the URI to the requested resource in the HTTP header or the device management platform 109 includes the requested resource in the message body following the HTTP standard. If the device management platform 109 determines that the resource is unavailable, the device management platform 109 responds with a status code (e.g., “404 Not Found”) and optionally provides more information in the HTTP header and/or message body.

In certain embodiments, the web client 103 (e.g., in a device management platform 109—initiated management operation) processes the address information (e.g., a Target URI) to determine one or more resource hierarchies associated with the UE 101 and then causes, at least in part, a selection of the one or more resources from the one or more resource hierarchies based, at least in part, on the device capability information, the device contextual information, the network information or a combination thereof. In particular, in an example use case where the device management platform 109 uses the POST or PUT method to create new management data or update existing management data in the UE 101, the web client 103 receives and processes the request including a Target URI, which is the URI identifying the management data in the UE 101 (e.g., the location of the management data in a hierarchal tree). As a result, the web client 103 should be able to access the management data and perform the requested management operation. More specifically, if the requested management data does not exist in the UE 101, the web client 103 should be able to create it, and if the management does exist in the UE 101, the web client 103 should be able to update it. Further, when a device management platform 109 used the POST method, if the device management platform 109 did not specify the exact location of the resource in the UE 101, the web client 103 should be to resolve the location and create and/or update it for the domain or management authority represented by the device management platform 109. For example, if settings are implemented as a hierarchical management tree in the UE 101, the device management platform 109 may not know the exact URI of the resource in the hierarchical tree of the UE 101. Therefore, the web client 103 should be able to update the operator settings of the device management platform 109 accordingly.

In one embodiment, the device management platform 109 (e.g., in a web client 103—initiated management operation), first processes the one or more transaction commands (e.g., a GET command) from the UE 101 (e.g., a mobile phone) to determine one or more resources (e.g., firmware) associated with the one or more management operations (e.g., updating software and firmware). The device management platform 109 then causes, at least in part, a transmission of the address information (e.g., a URI) associated with the one or more resources (e.g., one or more resources from the resource databases 113, the services platform 115, the services 117, the data providers 119, or a combination thereof) via one or more request-response protocols (e.g., HTTP). As previously discussed, if the device management platform 109 determines that the resource requested by the web client 103 is available (e.g., in the resource databases 113), then the device management platform 109 includes the URI to the requested resource in the HTTP header or includes the requested resource in the message body following the HTTP standard.

In certain embodiments, the device management platform 109 processes the one or more transaction commands (e.g., a POST command) to determine the device compatibility information, the device contextual information, the network information, or a combination thereof. In one example use case, a web client 103 uses the POST method to report the results of a management request or to provide management data to the device management platform 109. As previously discussed, the report should include an appropriate status code and additional information related to the processed management request.

In one embodiment, the device management platform 109 causes, at least in part, a transmission of one or more responses to the web client 103 of the UE 101 (e.g., a mobile phone) based on the one or more transaction commands (e.g., a POST command), the device capability information, the device contextual information, the network information, or a combination thereof. Consequently, the device management platform 109 may respond to the web client 103 with the status code “200 OK” after determining the results report from the web client 103. In an exemplary embodiment, the web client 103 sends one or more results reports for each management request. In one embodiment, the device management platform 109 causes, at least in part, one or more actions, one or more optimizations, or a combination thereof based, at least in part, on the one or more transaction commands (e.g., a POST command), the device capability information, the device contextual information (e.g., one or more results reports), the network information, or a combination thereof. More specifically, the device management platform 109 can take one or more appropriate actions if the device management platform 109 determines from the one or more results reports that there was a failure at any stage of the one or more management operations.

In certain embodiments, the device management platform 109 may also process the device capability information, the device contextual information, the network information, or a combination thereof to determine a status of the UE 101 (e.g., a mobile phone). More specifically, in an example use case involving a client-initiated management operation, the web client 103 (e.g., a web browser, a DM client, or a combination thereof) uses the POST or PUT method to send management data to the device management platform 109. For example, the web client 103 can send an entire management object to the device management platform 109. The device management platform 109 can then use the management object for diagnostic purposes to ensure that the configuration of the UE 101 is correct. Based on the results of the diagnostic evaluation, the device management platform 109 can cause, at least in part, a transmission of address information (e.g., a URI) based, at least in part, on the status of the UE 101.

In one embodiment, device management platform 109 causes, at least in part, a generation of one or more other resources associated with one or more management operations for the UE 101 based, at least in part, on the one or more transaction commands (e.g., a POST command). More specifically, in an example use case involving a device management platform 109-initiated management operation, the device management platform 109 uses the POST or PUT method to create new management data or to update existing management data in the UE 101. As previously discussed, the device management platform 109 then processes the device capability information, the device contextual information, the network information, or a combination thereof to determine one or more resource hierarchies associated with the UE 101. By way of example, the device management platform 109 determines the Target URI, which is the URI identifying the management data of the UE 101. For example, the URI can be the location of the management data organized as a hierarchical tree. In one embodiment, the device management platform 109 then causes, at least in part, a transmission of the address information (e.g., the URI) based, at least in part, on the one or more resource hierarchies. Again, as previously discussed, once the web client 103 receives the request and processes the request, the web client 103 should be able to access the management data and perform the requested management operation.

By way of example, the UE 101, the web client 103, the web server 107, the device management platform 109, the resource databases 113, the services platform 115, the services 117, and the data providers 119 communicate with each other and other components of the communication network 105 using well known, new or still developing protocols. In this context, a protocol includes a set of rules defining how the network nodes within the communication network 105 interact with each other based on information sent over the communication links The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the web client 103 and the device management platform 109 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

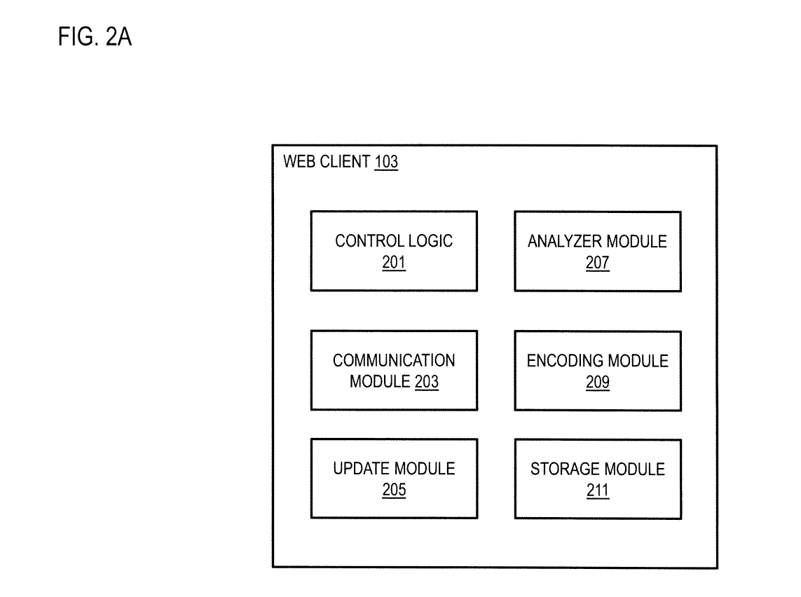

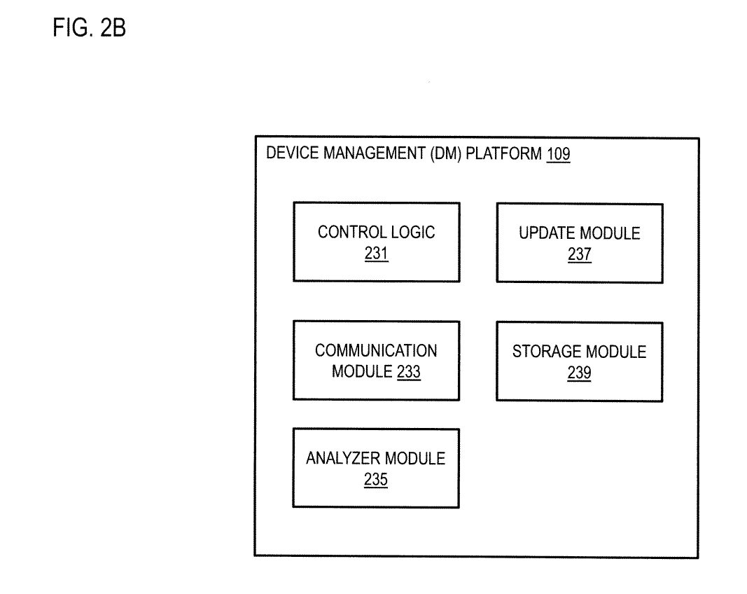

FIG. 2A is a diagram of the components of a web client 103, according to one embodiment. By way of example, the web client 103 includes one or more client side components for remotely managing mobile devices utilizing one or more request-response protocols. It is contemplated that the functions of these components may be combined in one or more components or performed by other components of equivalent functionality. In this embodiment, the web client 103 includes a control logic 201, a communication module 203, an update module 205, an analyzer module 207, an encoding module 209, and a storage module 211.

The control logic 201 oversees tasks, including tasks performed by the communication module 203, the update module 205, the analyzer module 207, the encoding module 209, and the storage module 211. For example, although the other modules may perform the actual task, the control logic may determine when and how those tasks are performed or otherwise direct the other modules to perform the task.

The communication module 203 is used for communication between the web client 103 of the UE 101 and the device management platform 109 of the web server 107. The communication module 203 is also used for communication between the web client 103 and the user interface (UI) 111 of the UE 101, the device management platform 109 and resource databases 113 of the web server 107, the services 117 of the services platform 115, and the data providers 119. The communication module 203 may be used to communicate commands, requests, data, etc. The communication module 203 also may be used to transmit the one or more transaction commands (e.g., a GET command) to at least one server (e.g., the device management platform 109) according to the one or more request-response protocols (e.g., HTTP). By way of example, in one embodiment, the communication module 203 is used to facilitate a HTTP GET on a resource URI. The communication module 203 also may be used to facilitate the POST or PUT method to report the results of the management request or to provide management data to the at least one server (e.g., the device management platform 109). More specifically, the PUT method is used when the exact URI of the resource is known. In addition, the communication module 203 may also be used to send one or more Alerts or Notifications to the at least one server using the POST method when an event occurred in the at least one device.

The update module 205, in connection with the control logic 201 and the analyzer module 207, is used to determine one or more management operations for at least one device (e.g., a mobile phone or tablet), one or more resources associated with the one or more management operations (e.g., management data and/or one or more resources), or a combination thereof. In addition, in the example use case where the requested management data does not exist in the device, the update module 205 may also be used to create it, and if the management data does exist in the device, the update module 205 should be able to update it. Further, in the example use case where the at least one server did not specify the exact location of the resource in the device, the update module 205 also may be used, in connection with the storage module 211, to create and/or update it for the domain or management authority represented by the server.

The analyzer module 207 is used to process the one or more management operations (e.g., updating firmware in the mobile device), the one or more resources (e.g., firmware in binary form), or a combination thereof to determine one or more transaction commands for completing the one or more management operations, wherein the one or more transaction commands are realized, at least in part, via one or more request-response protocols (e.g., HTTP). By way of example, the analyzer module 207 may determine to use the GET, POST, and/or PUT methods in order to complete the one or more management operations. The analyzer module 207 may also be used to identify the one or more management operations, the one or more resources, or a combination thereof in the one or more transactions using one or more resource identifiers (e.g., a URI).

In one embodiment, the analyzer module 207 also may be used to determine address information (e.g. a URI) for the one or more management operations, the one or more resources, or a combination thereof in response to the transmission of one or more transaction commands. By way of example, if the at least one device (e.g., the UE 101) requests a resource and the requested resource is available, the at least one server (e.g., the device management platform 109) includes the URI to the requested resource in the HTTP header, the analyzer module 207 may be used to determine the URI to locate the requested resource. In another example use case, where the server determines the resource is unavailable and responds with a status code (e.g., “404 Not Found”), the analyzer module 207 also may be used to determine the status code. Further, in one embodiment the analyzer module 207 is used to process the address information (e.g., a Target URI) to determine one or more resource hierarchies associated with the device.

The encoding module 209 is used to encode the device capability information, device contextual information, network information, or a combination thereof in the one or more transaction commands. More specifically, the encoding module 209 is used to encode parameters associated with a URI that uniquely identify the requested resource (e.g., firmware) for the specific device (e.g., the UE 101) by the entity processing the request (e.g., the device management platform 109). By way of example, the encoding module 209 may be used to encode a resource URI as follows: “<RESOURCE URI>? <sn>&<pc>&<sv>&<id>&<init>&<sim_mnc>&<sim_mcc>&<nw_mnc>&<nw_mcc>&<APN>”, wherein the parameters encoded by the encoding module 209 respectively specify the Serial Number of the Device, the Product Code, language (e.g., Swedish), the ID used in reports, Request Initiated, Mobile network code of SIM for zero rating, Mobile country code of SIM for zero rating, Mobile network code of network for zero rating, mobile country code of network for zero rating, and APN. In certain embodiments, the encoding module 209 may also include a SPN in the resource URI.

The storage module 211 is used to cause, at least in part, a selection of the one or more resources from the one or more resource hierarchies based, at least in part, on the device capability information, the device contextual information, the network information, or a combination thereof. More specifically, in an example use case where the at least one server (e.g., the device management platform 109) uses the POST or PUT method to create new management data or to update existing management in at least one device (e.g., the UE 101), the web client 103 receives and processes the request including a Target URI, which is the URI identifying the management data in the UE 101 (e.g., the location of the management data organized as a hierarchical tree). As a result, the storage module 211 should be able to access the management data and, in connection with the control logic 201, facilitate the requested management operation. In another embodiment, where the at least one server used the POST method, if the server did not specify the exact location of the resource in the device, the storage module 211 should be able to resolve the location and, in connection with the update module 205, create and/or update it for the domain or management authority represented by the server.

FIG. 2B is a diagram of the components of a Device Management (DM) platform 109, according to one embodiment. By way of example, the device management platform 109 includes one or more server side components for remotely managing mobile devices utilizing one or more request-response protocols. It is contemplated that the functions of these components may be combined in one or more components or performed by other components of equivalent functionality. In this embodiment, the device management platform 109 includes a control logic 231, a communication module 233, an analyzer module 235, an update module 237, and a storage module 239.

Similar to the control logic 201 of the web client 103, the control logic 231 oversees tasks, including tasks performed by the communication module 233, the analyzer module 235, the update module 237, and the storage module 239. For example, although the other modules may perform the actual task, the control logic may determine when and how those tasks are performed or otherwise direct the other modules to perform the task.

Similar to the communication module 203 of the web client 103, the communication module 233 is used for communication between the device management platform 109 of the web server 107 and the web client 103 of the UE 101. The communication module 233 is also used for communication between the web client 103 and the user interface (UI) 111 of the UE 101, the device management platform 109 and resource databases 113 of the web server 107, the services 117 of the services platform 115, and the data providers 119. The communication module 233 may be used to communicate commands, requests, data, etc.

In one embodiment, the communication module 233 may also be used to transmit address information (e.g., a URI) associated with the one or more resources via one or more request-response protocols (e.g., HTTP). The communication module 233 also may be used to transmit one or more responses to the at least one device (e.g., the UE 101) based on the one or more transaction commands (e.g., a POST command), the device capability information, the device contextual information, the network information, or a combination thereof. As previously discussed, the communication module 203 may send the one or more results reports asynchronously to at least one server (e.g., the device management platform 109) in a new session following the processing of a management request. Consequently, the communication module 233 may respond to the device with the status code “200 OK” after the analyzer module 235 determines the results report from the device. In addition, the communication module 233 may also be used to transit the address information (e.g., a URI) to the device based, at least in part, on the status of the device. By way of example, the communication module 233 can transit the URI to the correct configuration to the device and the communication module 203, in connection with the storage module 211, can retrieve the correction configuration and store it in the Client URI, which can also be the location of the configuration object in a hierarchical management tree. Further, in certain embodiments, the communication module 233 also may be used to transmit the address information (e.g., a URI) based, at least in part, on the one or more resource hierarchies.

The analyzer module 235 is used to process the one or more transaction commands (e.g., a GET command) from at least one device (e.g., the UE 101) to determine one or more resources (e.g., firmware) associated with the one or more management operations (e.g., updating software and firmware). The analyzer module 235 may also be used to process the one or more transaction commands (e.g., a POST command) to determine the device capability information, the device contextual information, the network information, or a combination thereof. By way of example, the analyzer module 235 may be used to analyze the one or more results reports transmitted to at least one server by at least one device using the POST method. More specifically, the analyzer module 235 is used to determine appropriate status code and additional information related to the processed management request contained within each results report. In addition, the analyzer module 235 may also be used in connection with the update module 237 to process the device capability information, the device contextual information, the network information, or a combination thereof to determine a status of the device (e.g., the UE 101). As previously discussed, in one example use case, the device uses the POST or PUT method to send management data to the server (e.g., an entire management object). The analyzer module 235, in connection with the update module 237, may then be used for diagnostic purposes to ensure that the configuration of the device is correct. Further, the analyzer module 235 also may be used to process the device capability information, the device contextual information, the network information, or a combination thereof to determine one or more resource hierarchies associated with the device. By way of example, the analyzer module 235 may also be used to determine the Target URI.

The update module 237 is used to cause, at least in part, one or more actions, one or more optimizations, or a combination thereof based, at least in part, on the one or more transaction commands (e.g., a POST command), the device capability information, the device contextual information (e.g., one or more results reports). More specifically, the update module 237 can cause at least one server (e.g., the device management platform 109) to take one or more appropriate actions if the update module 237, in connection with the analyzer module 235, determines that there was a failure at any stage of the one or more management operations. In certain embodiments, the update module 237 may also be used to generate one or more other resources associated with one or more management operations for at least one device (e.g., the UE 101) based, at least in part, on the one or more transaction commands (e.g., a POST command). More specifically, in an example use case involving a server-initiated management operation, the update module 237 may use the POST or PUT method to create new management data or to update existing management data in the device.

The storage module 239, in connection with the update module 237, is used to manage the storage of the one or more resources associated with the one or more management operations (e.g., management data and/or one or more resources), which may be stored in the one or more databases (e.g., resource databases 113) associated with the device management platform 109.

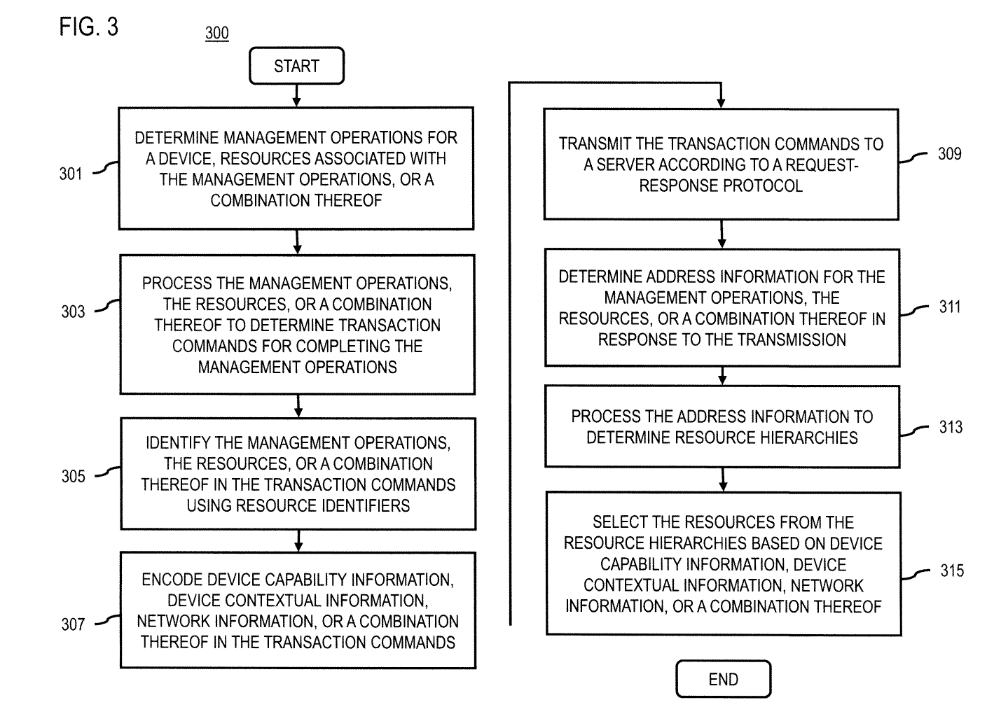

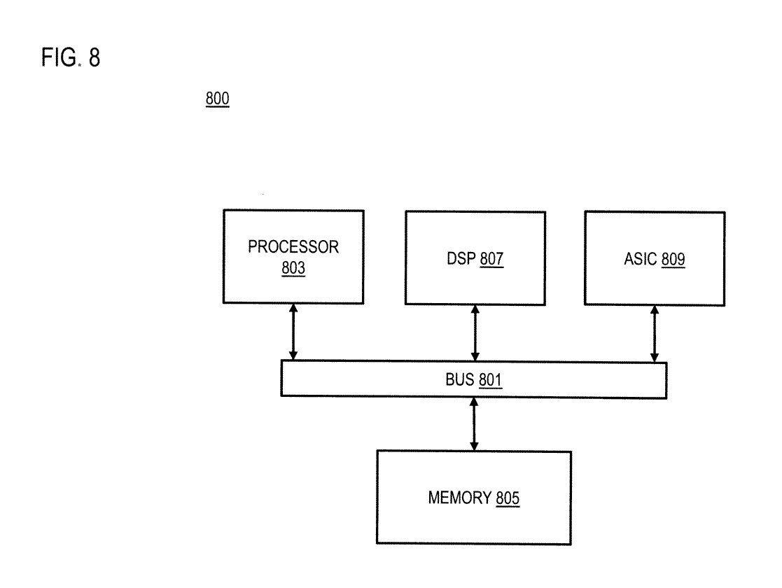

FIG. 3 is a flowchart of the client side process for remotely managing mobile devices utilizing one or more request-response protocols, according to one embodiment. In one embodiment, the web client 103 performs the process 300 and is implemented in, for instance, a chip set including a processor and a memory as shown in FIG. 8. In step 301, the web client 103 determines one or more management operations for at least one device, one or more resources associated with the one or more management operations, or a combination thereof. By way of example, the one or more management operations may include such scenarios as updating software and firmware in a device; updating configuration settings; automatic and manual updates; server and client-initiated updates and management operations; retrieving management data from one or more devices; and provisioning a wireless device purchased in a retail market with a consumer selected service provider as opposed to provisioning the device through the operator channel or in-store provisioning in a closed ecosystem. In addition, the one or more resources include both management data and one or more resources. More specifically, management data can refer to any one of the following: configuration settings required for the mobile device to seamlessly operate over those networks; application settings; software or firmware; device information and capabilities; hardware capabilities, configuration and control information for hardware attached to the mobile device; logs, measurements, diagnostic data, and a catalog providing information on updatable components (e.g., software or firmware, menus, etc.). Further the one or more resources can refer to one or more catalogs providing information on resources (e.g., the URL of the location where the resources are available as well as different versions modified since the specified date); software components and firmware in binary form; configuration data and settings (e.g., policy configuration, account settings, connectivity settings); and one or more single parameter values (e.g., a value of a single parameter in the connectivity settings).

In step 303, the web client 103 processes and/or facilitates a processing of the one or more management operations, the one or more resources, or a combination thereof to determine one or more transaction commands for completing the one or more management operations, wherein the one or more transaction commands are realized, at least in part, via one or more request-response protocols. By way of example, the one or more transaction commands include one or more of the nine methods indicating a desired action to be performed on the identified resource (e.g., HEAD, GET, POST, PUT, DELETE, TRACE, OPTIONS, CONNECT, and PATCH). More specifically, in one embodiment, web client 103 performs a HTTP GET on a resource URI and later uses the POST method to report the results of a management request or to provide management data to at least one server (e.g., the device management platform 109). In addition, the web client 103 may also send one or more Alerts or Notifications to the server using the POST method when one or more events occur in the device. Further, while a multitude of request-response protocols are available, the various embodiments of the present invention disclosed herein use HTTP for the sake of explanation.

In step 305, the web client 103 causes, at least in part, an identification of the one or more management operations, the one or more resources, or a combination thereof in the one or more transaction commands using one or more resource identifiers. By way of example, the one or more resource identifiers include, at least in part, one or more URIs. More specifically, the one or more resources that are managed in one or more devices are uniquely identified through a URI.

In step 307, the web client 103 causes, at least in part, an encoding of device capability information, device contextual information, network information, or a combination thereof in the one or more transaction commands, wherein the address information is determined based, at least in part, on the device capability information, the contextual information, the network information, or a combination thereof. By way of example, the device capability information, device contextual information, network information, or a combination thereof relate to the parameters that uniquely identify the requested resource (e.g., firmware) for the specific device (e.g., the UE 101) by the entity processing the request (e.g., the device management platform 109). More specifically, for a client-initiated request, a resource URI may have the following generic form: “<RESOURCE URI>? <sn>&<pc>&<sv>&<id>&<init>&<sim_mnc>&<sim_mcc>&<nw_mnc>&<nw_mcc>&<APN>”, wherein the encoded parameters respectively specify the Serial Number of the Device, the Product Code, language (e.g., Swedish), the ID used in reports, Request Initiated, Mobile network code of SIM for zero rating, Mobile country code of SIM for zero rating, Mobile network code of network for zero rating, mobile country code of network for zero rating, and APN. In certain embodiments, the resource URI may also include a SPN. In addition, HTTP header fields in the request (e.g., standard fields or non-standard fields) can be used to provide required parameters for one or more management operations. For example, including the current version of a resource in at least one device (e.g., the UE 101) allows at least one server (e.g., the device management platform 109) to determine if there is a newer version of the resource available.

In step 309, the web client 103 causes, at least in part, a transmission of the one or more transaction commands to at least one server according to the one or more request-response protocols. As previously discussed, the one or more transaction commands include one or more of the nine methods indicating a desired action to be on the identified resource (e.g., GET, POST, PUT, etc.). In one example use case, at least one server responds to the request with a standard HTTP response, which may include a message body.

In step 311, the web client 103 determines address information for the one or more management operations, the one or more resources, or a combination thereof in response to the transmission. By way of example, if at least one device (e.g., the UE 101) requests a resource and the requested resource is available (e.g., in the resource databases 113), at least one server (e.g., the device management platform 109) includes the address information (e.g., a URI) to the requested resource in the HTTP header or the server includes the requested resource in the message body following the HTTP standard. However, if the server determines that the resource is unavailable, the server responds with a status code (e.g., “404 Not Found”) and optionally provides more information in the HTTP header and/or message body. It is contemplated that in this context, the address information may include both the URI and/or the status code.

In step 315, the web client 103 processes and/or facilitates a processing of the address information to determine one or more resource hierarchies and in step 317, the web client 103 causes, at least in part, a selection of the one or more resources from the one or more resource hierarchies based, at least in part, on the device capability information, the device contextual information, the network information, or a combination thereof. By way of example, in an example use case where at least one server (e.g., a device management platform 109) uses the POST or PUT method to create new management data or to update existing management data in at least one device (e.g., the UE 101), the web client 103 receives and processes the request including a Target URI. As a result, the web client 103 should be able to access the management data and perform the requested management operation. More specifically, if the requested management data does not exist in the device, the web client 103 should be able to create it, and if the management data does exist in the device, the web client 103 should be able to update it. Further, when the server is using the POST method, if the server did not specify the exact location of the resource in the device, the web client 103 should be able to resolve the location and create and/or update it for the domain or management authority represented by the server. For example, if settings are implemented as a hierarchical management tree in the device, an operator server may not know the exact URI of the resource in the hierarchical tree of the device. Therefore, the web client 103 should be able to update the operator settings accordingly.

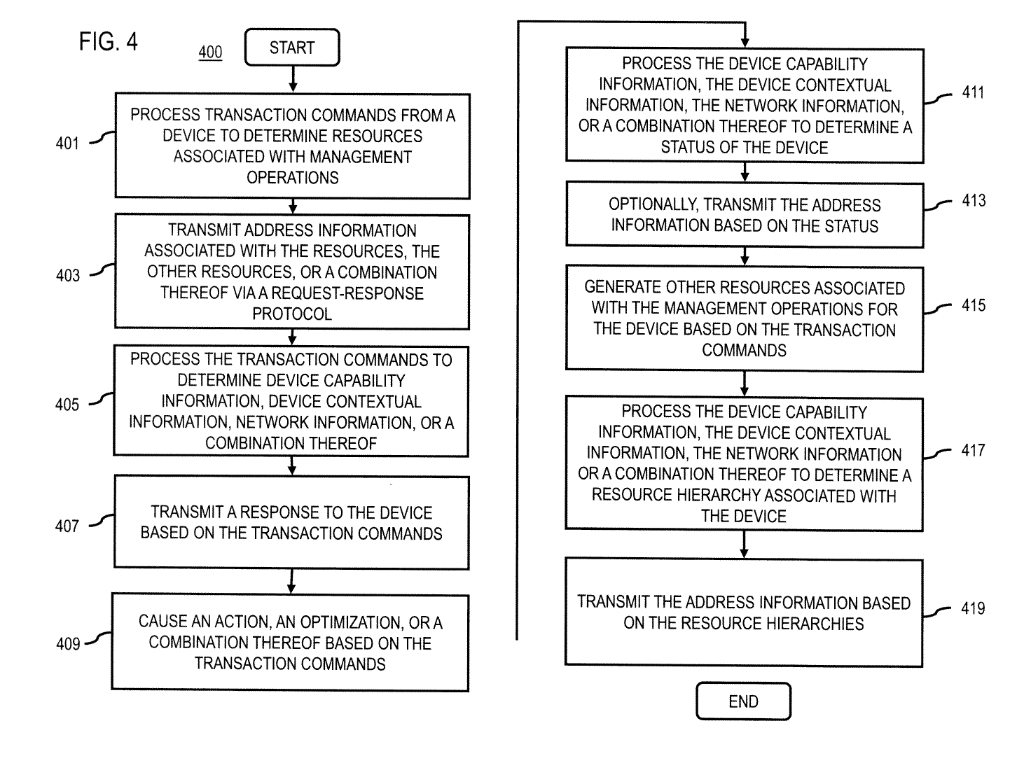

FIG. 4 is a flowchart of the server side process for remotely managing mobile devices utilizing one or more request-response protocols, according to one embodiment. In one embodiment, the device management platform 109 performs the process 400 and is implemented in, for instance, a chip set including a processor and a memory as shown in FIG. 8. In step 401, the device management platform 109 processes and/or facilitates a processing of one or more transaction commands from at least one device to determine one or more resources associated with one or more management operations. As previously discussed, the one or more transaction commands include one or more of the nine methods indicating the desired action to be performed on the identified resource (e.g., GET, POST, PUT, etc.).

In step 403, the device management platform 109 causes, at least in part, a transmission of address information associated with the one or more resources, the one or more other resources, or a combination thereof via one or more request-response protocols. As previously discussed, in certain embodiments, the address information includes both a URI and/or a status code and the one or more request-response protocols include HTTP.

In step 405, the device management platform 109 processes and/or facilitates a processing of the one or more transaction commands to determine device capability information, device contextual information, network information, or a combination thereof. By way of example, in one example use case, the device management platform 109 may determine the device capability information, the device contextual information, the network information, or a combination thereof from the results of a management request or the management data provided to at least one server by at least one device (e.g., the UE 101) using the POST method. More specifically, in an exemplary embodiment, the report should include an appropriate status code and additional information related to the processed management request. In addition, the standard HTTP header fields can be used by the device to provide information to the device management platform 109 on the content type, compression scheme, etc. and/or the HTTP header may include non-standard fields for specific management needs. Further, in an exemplary embodiment, the device sends one or more results reports for each management request. For example, the device can generate the following four reports for a firmware update: (1) After discovery (time taken to download the catalog); (2) After download (the status is “Download OK,” “Download failed,” “File corrupt during download,” “Resume download was needed,” etc.); (3) After user acceptance (installation has started); and (4) After installation (installation time, if server does not receive this report, it means the device is broken).

In step 407, the device management platform 109 causes, at least in part, a transmission of one or more responses to the at least one device based, at least in part, on the one or more transaction commands. By way of example, based on the one or more results reports determined by the device management platform 109 from at least one device (e.g., the UE 101), the device management platform 109 may respond to the device with the status code “200 OK.” As previously discussed, in one embodiment, if the device does not receive the status code “200 OK,” the device will send the report until the device management platform 109 receives it.

In step 409, the device management platform 109 causes, at least in part, one or more actions, one or more optimizations, or a combination thereof based, at least in part, on the one or more transaction commands. By way of example, the device management platform 109 can take one or more appropriate actions if the device management 109 determines from the one or more reports that there was a failure at any stage of the one or more management operations.

In step 411, the device management platform 109 processes and/or facilitates a processing of the device capability information, the device contextual information, the network information, or a combination thereof to determine a status of the at least one device. By way of example, in an example use case involving a client-initiated management operation, the at least one device (e.g., the UE 101) uses the POST or PUT method to send management data to the device management platform 109. For example, the UE 101 can send an entire management object to the device management platform 109. The device management platform 109 can then use the management object for diagnostic purposes (i.e., determine a status of the UE 101) to ensure that the configuration of the device is correct.

In step 413, the device management platform 109 optionally causes, at least in part, a transmission of the address information based, at least in part, on the status. By way of example, based on the results of the diagnostic evaluation, the device management platform 109 can cause, at least in part, a transmission of the address information (e.g., a URI) based, at least in part, on the status of at least one device (e.g., the UE 101). Further, the device management platform 109 can provide the device with the URI to the correct configuration and the device can retrieve the correct configuration and store it in the Client URI. It is contemplated that the device management platform 109 would not transmit the address information if the device management platform 109 determined the configuration of the device was correct.

In step 415, the device management platform 109 causes, at least in part, a generation of one or more other resources associated with one or more management operations for the at least one device based, at least in part, on the one or more transaction commands. For example, in an example use case involving a server-initiated management operation, the device management platform 109 uses the POST or PUT method to create new management data or to update existing management data in at least one device (e.g., the UE 101).

In step 417, the device management platform 109 processes and/or facilitates a processing of the device capability information, the device contextual information, the network information, or a combination thereof to determine one or more resource hierarchies associated with the at least one device. By way of example, as previously discussed, the device management platform 109 determines the Target URI, which is the URI identifying the management data of the device. For example, the URI can be the location of the management data organized as a hierarchical tree.

In step 419, the device management platform 109 causes, at least in part, a transmission of the address information based, at least in part, on the one or more resource hierarchies. Again, as previously discussed, once the web client 103 receives the request from the device management platform 109 and processes the request, the web client 103 should be able to access the management data and perform the requested management operation.

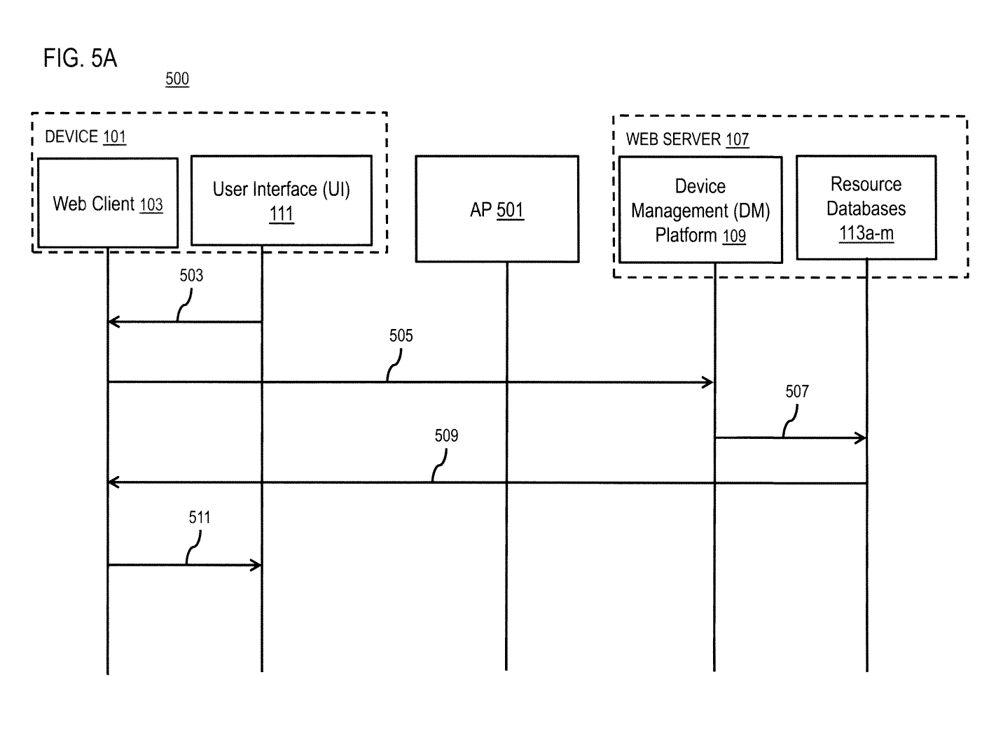

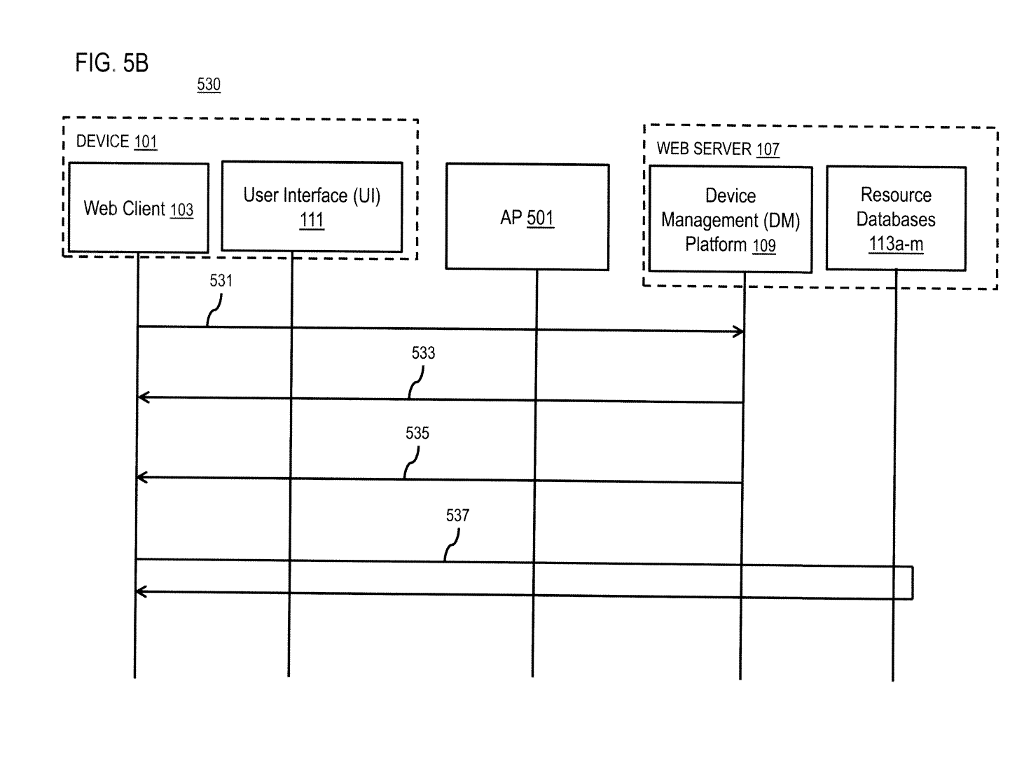

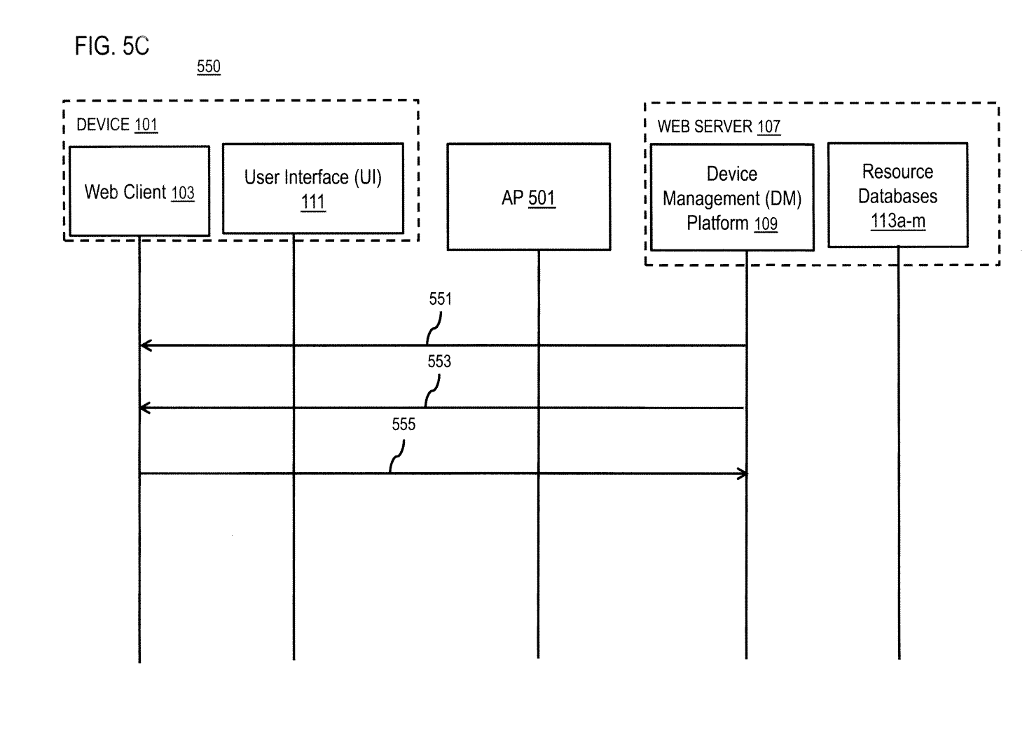

FIGS. 5A-5C are ladder diagrams that illustrate a sequence of messages and processes for remotely managing mobile devices utilizing one or more request-response protocols, according to one embodiment. FIG. 5A is a ladder diagram that illustrates a sequence of messages and processes for client-initiated management operations involving the GET command. The processes in the diagram 500 include a device 101 (e.g., the UE 101) which further includes a web client 103 (e.g., a web browser, a DM client, or a combination thereof) and a user interface (UI) 111 (e.g., a graphical user interface (GUI)). In addition, an access point (AP) 501 to a communication network 105 and a web server 107 which further includes a device management platform 109 and one or more resource databases 113a-113m are depicted. A network process is represented by a thin vertical line. A step or message passed from one process to another is represented by horizontal arrows. In step 503, the user interface (UI) 111 of the device 101 (e.g., a mobile phone) determines one or more management operations for the device 101 (e.g., updating firmware in the mobile device), one or more resources associated with the one or more management operations (e.g., firmware in binary form), or a combination thereof. The web client 103 then processes the one or more management operations, the one or more resources, or a combination thereof to determine one or more transaction commands for completing the one or more management operations (e.g., a GET command), wherein the one or more transaction commands are realized, at least in part, via one or more request-response protocols (e.g., HTTP). In one embodiment, the web client 103 next causes, at least in part, an identification of the one or more management operations, the one or more resources, or a combination thereof in the GET command using one or more resource identifiers, wherein in the one or more resource identifiers include, at least in part, one or more URIs. In certain embodiments, the web client 103 then causes, at least in part, an encoding of device capability information (e.g., of the device 101), device contextual information, network information, or a combination thereof in the one or more transaction commands, wherein the address information is determined based, at least in part, on the device capability information, the contextual information, the network information, or a combination thereof. More specifically, in this example use case, the URI includes encoded parameters to uniquely identify the requested resource (e.g., firmware) for the specified device (e.g., the device 101) by the entity processing the request (e.g., the device management platform 109).

In step 505, the web client 103 causes, at least in part, a transmission of the GET command to the device management platform 109 of the web server 107 according to one or more request-response protocols (e.g., HTTP). In step 507, the device management platform 109 determines address information (e.g., a URI) for the one or more management operations (e.g., updating firmware), the one or more resources (e.g., firmware in binary form), or a combination thereof in response to the transmission of the GET command from the web client 103, corresponding to step 505. In step 509, the device management platform 109 in connection with the resource databases 113 (i.e., step 505) responds to the GET command with a standard HTTP response, which may include a message body. More specifically, if the device requests a resource and the requested resource is available, the device management platform 109 includes the URI to the requested resource in the HTTP header or the server includes the requested resource in the message body following the HTTP standard. However, if the device management platform 109 determines that the resource is unavailable, the device management platform 109 responds in step 509 with a status code (e.g., “404 Not Found”) and optionally provides more information in the HTTP header and/or message body. In step 511, the web client 103 causes, at least in part, a presentation of one or more Alerts or Notifications to the user interface 111 to inform an end user that an event occurred in the device. By way of example, for a server-initiated management operation (not shown for illustrative purposes), the device management platform 109 may use the GET command to retrieve management data from the device 101.

FIG. 5B is a ladder diagram that illustrates a sequence of messages and processes for client-initiated management operations involving the POST or PUT command. In step 531, the web client 103 causes, at least in part, one or more transmissions of one or more transaction commands (e.g., a POST command) to the device management platform 109 to report the results of the management request (e.g., corresponding to step 509) or to provide management data to the device management platform 109. In step 533, the device management platform 109 may respond to the web client 103 with the status code “200 OK” after determining the results report from the web client 103. If, however, the web client 103 does not receive the status code “200 OK” corresponding to step 533, the web client 103 will send the report again until the device management platform 109 receives it.

In an exemplary embodiment, the web client 103 sends one or more results reports corresponding to step 531 for each management request. For example, the at least one device can generate the following four reports for a firmware update: (1) After discovery (time taken to download the catalog); (2) After download (the status is “Download OK,” “Download failed,” “File corrupt during download,” “Resume download was needed,” etc.); (3) After user acceptance (installation has started); and (4) After installation (installation time, if server does not receive this report, it means the device is broken). In one embodiment, the system 100 then causes, at least in part, one or more actions, one or more optimizations, or a combination thereof based, at least in part, on the one or more transaction commands (e.g., a POST command), the device capability information, the device contextual information (e.g., one or more results reports), the network information, or a combination thereof. In one embodiment, the device management platform 109 can use the one or more results reports corresponding to step 531 for diagnostic purposes to ensure the configuration of the web client 103 is correct. In step 535, the device management platform 109, based on the results of the diagnostic evaluation, can cause, at least in part, a transmission of the address information (e.g., a URI) based, at least in part, on the status of the web client 103. More specifically, the device management platform 109 can provide the web client 103 with the URI to the correct configuration. In step 537, the web client 103 can retrieve the correct configuration (e.g., from the resource databases 113) and store it in the Client URI.

FIG. 5C is a ladder diagram that illustrates a sequence of messages and processes for server-initiated management operations involving the POST or PUT command. In one embodiment, the device management platform 109 causes, at least in part, a generation of one or more other resources associated with one or more management operations (e.g., updating firmware) for the device 101 based, at least in part, on the one or more transaction commands transmitted by the web client 103 (e.g., a POST command corresponding to step 531). More specifically, the device management platform 109 uses the POST or PUT method to create new management data or to update existing management data in the device 101. In step 551, the device management platform 109 causes, at least in part, a transmission of one or more short message service (SMS) messages to the device 101 in order to start the action. In one embodiment, the device management platform 109 processes the device capability information, the device contextual information, the network information, or a combination thereof to determine or more resource hierarchies associated with the device 101. By way of example, the device management platform 109 determines the Target URI, which is the URI identifying the management data of the device 101. In step 553, the device management platform 109 causes, at least in part, a transmission of the address information (e.g., the URI) based, at least in part, on the one or more resource hierarchies. By way of example, once the web client 103 receives the request and processes the request (e.g., 302 Found; URL of the server or a catalog in XML form), the web client 103 should be able to access the management data and perform the requested management operation. More specifically, if the requested management data does not exist in the device 101, the web client 103 should be able to create it, and if the management data does exist in the device 101, the web client 103 should be able to update it. Further, when the device management platform 109 is using the POST method, if the device management platform 109 did not specify the exact location of the resource in the device 101, the web client 103 should be able to resolve the location and create and/or update it for the domain or management authority represented by the device management platform 109. For example, if settings are implemented as a hierarchical management tree in the device 101, an operator server may not know the exact URI of the resource in the hierarchical tree of the device 101. In step 555, the web client 103 can cause, at least in part, a transmission of one or more notifications to the device management platform 109 in order to update the operator settings accordingly.

In another embodiment, the web client 103 causes, at least in part, a transmission of one or more transaction commands (e.g., a GET command) to the device management platform 109. In response, the device management platform 109 determines whether the resource requested by the web client is available and if so, causes, at least in part, a transmission of a response including, at least in part, a status code (e.g., “302 Found”) and the URL to the requested resource in the HTTP header or the device management platform 109 includes one or more catalogs (e.g., in XML form) in the message body following the HTTP standard. As a result, the web client 103 then performs a HTTP GET on the resource URL as identified by the device management platform 109. In response, the device management platform 109 causes, at least in part, a transmission of a response to the web client 103 including, at least in part, the status code “200 OK” along with the one or more catalogs (e.g., in XML form) located in the one or more resource databases 113.

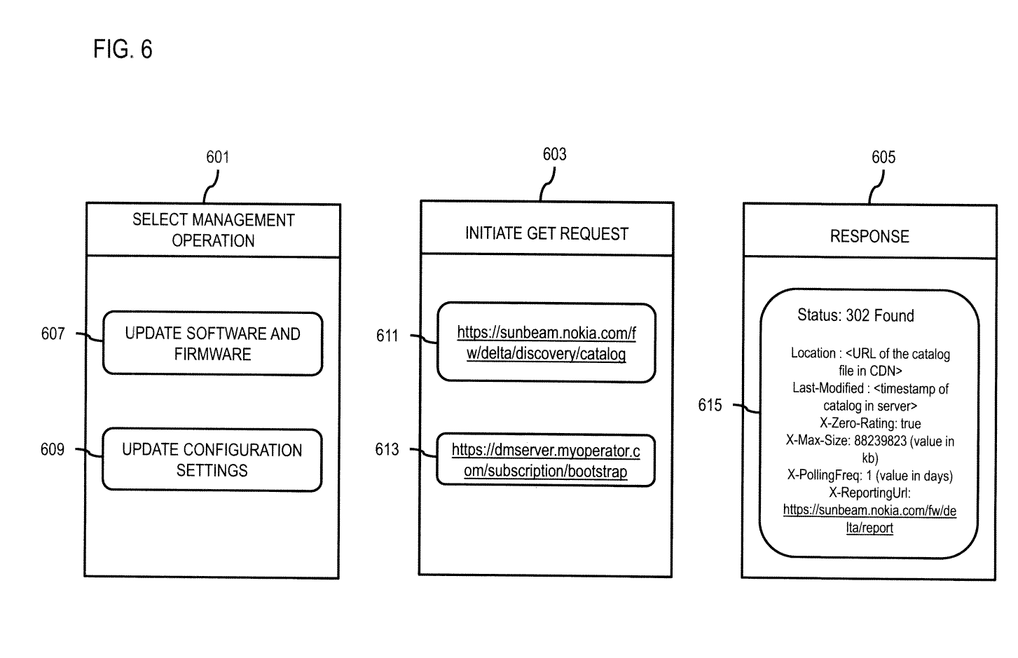

FIG. 6 is a diagram of user interfaces utilized in the processes of FIGS. 3 and 4, according to various embodiments. As shown, the example user interfaces of FIG. 6 include one or more user interface elements and/or functionalities created and/or modified based, at least in part, on information, data, and/or signals resulting from the processes (e.g., processes 300 and 400) described with respect to FIGS. 3 and 4. More specifically, FIG. 6 illustrates three user interfaces (e.g., interfaces 601, 603, and 605) depicting various client side embodiments of at least one device (e.g., a mobile phone and/or the UE 101). In particular, FIG. 6 depicts how a client-initiated management operation involving the GET command obtains address information associated with a requested resource (e.g., firmware) from at least one server. In one embodiment, the system 100 first determines one or more management operations (e.g., updating firmware) for at least one device, one or more resources associated with the one or more management operations (e.g., management data and/or one or more resources), or a combination thereof. As shown in interface 601, a web client prompts a user to select one or more management operations (e.g., update software and firmware 607 or update configuration settings 609). The system 100 then processes the selection of the one or more management operations (e.g., updating software and firmware 607), the one or more resources (e.g., firmware in binary form), or a combination thereof to determine one or more transaction commands for completing the one or more management operations (e.g., GET, POST, PUT, etc.), wherein the one or more transaction commands are realized, at least in part, via one or more request-response protocols (e.g., HTTP).

In one embodiment, the system 100 next causes, at least in part, an identification of the one or more management operations, the one or more resources, or a combination thereof in the one or more transaction commands (e.g., a GET command) using one or more resource identifiers, wherein the one or more resource identifiers include, at least in part, one or more URIs. As shown in interface 603, the system 100 determined to perform a HTTP GET on a resource URI. In certain embodiments, the system 100 then causes, at least in part, an encoding of device capability information, device contextual information, network information, or a combination thereof in the one or more transaction commands, wherein the address information (e.g., a URI) is determined based, at least in part, on the device capability information, the contextual information, the network information, or a combination thereof. As further shown in interface 603, the web client prompts the user to select one or more <RESOURCE URIs> (e.g., a URI to a phone company server for the discovery of a catalog for firmware updates 611 or a URI to retrieve bootstrap information from an operator server 613).

In one embodiment, the system 100 next causes, at least in part, a transmission of the GET command to at least one server (e.g., the device management platform 109) according to one or more request-response protocols (e.g., HTTP). As shown in interface 605, in this example use case, the server responds to the request of interface 603 with a standard HTTP response 615. More specifically, the response 615 from the server includes a status code (e.g., “303 See Other”), a URI or a URL to the requested resource in the HTTP header, and may include additional information in the HTTP header and/or message body (not shown for illustrative purposes). As a result, the device should be able to access the requested resource and perform the requested management operation.

The processes described herein for remotely managing mobile devices utilizing one or more request-response protocols may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

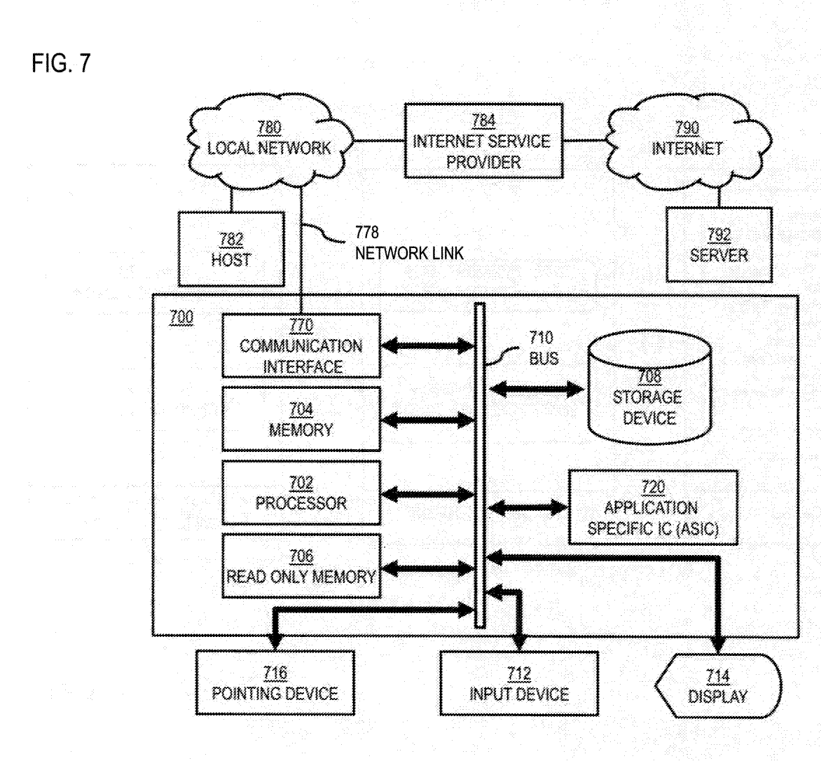

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to remotely manage mobile devices utilizing one or more request-response protocols as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of remotely managing mobile devices utilizing one or more request-response protocols.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to remotely manage mobile devices utilizing one or more request-response protocols. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for remotely managing mobile devices utilizing one or more request-response protocols. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for remotely managing mobile devices utilizing one or more request-response protocols, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for remotely managing mobile devices utilizing one or more request-response protocols to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to remotely manage mobile devices utilizing one or more request-response protocols as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of remotely managing mobile devices utilizing one or more request-response protocols.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to remotely manage mobile devices utilizing one or more request-response protocols. The memory 805 also stores the data associated with or generated by the execution of the inventive steps.

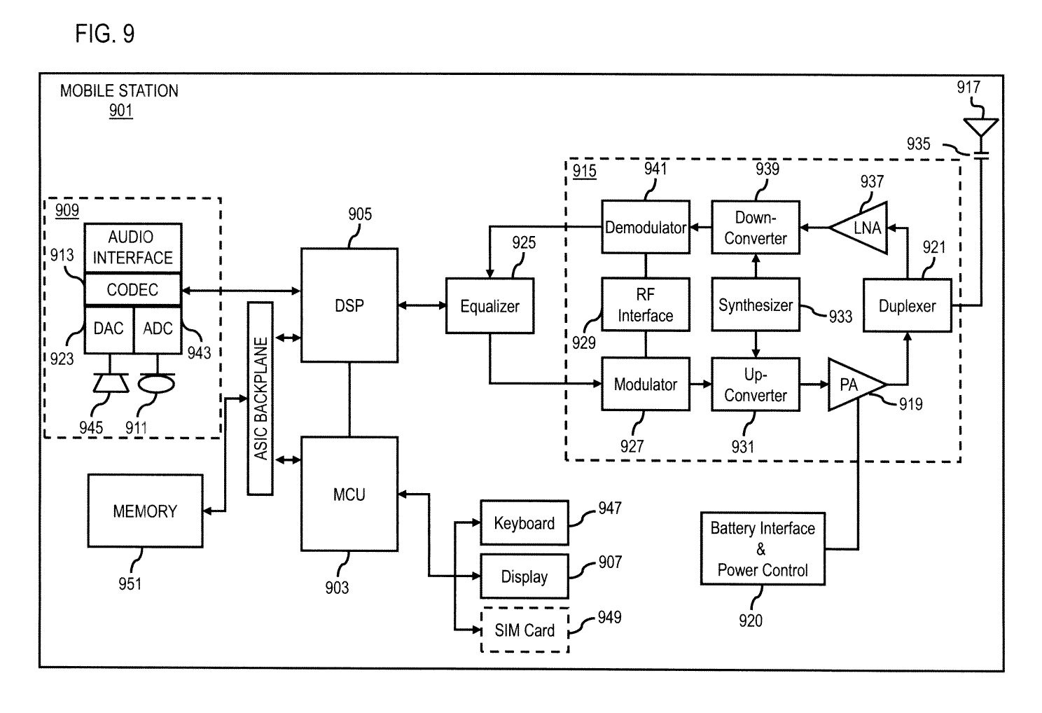

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of remotely managing mobile devices utilizing one or more request-response protocols. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of remotely managing mobile devices utilizing one or more request-response protocols. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to remotely manage mobile devices utilizing one or more request-response protocols. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more management operations for at least one device, one or more resources associated with the one or more management operations, or a combination thereof;
a processing of the one or more management operations, the one or more resources, or a combination thereof to determine one or more transaction commands for completing the one or more management operations,
wherein the one or more transaction commands are realized, at least in part, via one or more request-response protocols.

2. A method of claim 1, wherein the (1) data and/or (2) information and/or (3) at least one signal are further based, at least in part, on the following:
an identification of the one or more management operations, the one or more resources, or a combination thereof in the one or more transaction commands using one or more resource identifiers.

3. A method of claim 2, wherein the one or more request-response protocols includes, at least in part, a Hypertext Transport Protocol (HTTP); and wherein the one or more resource identifiers include, at least in part, one or more Uniform Resource Identifiers (URIs).

4. A method of claim 1, wherein the (1) data and/or (2) information and/or (3) at least one signal are further based, at least in part, on the following:
a transmission of the one or more transaction commands to at least one server according to the one or more request-response protocols; and
at least one determination of address information for the one or more management operations, the one or more resources, or a combination thereof in response to the transmission.

5. A method of claim 4, wherein the (1) data and/or (2) information and/or (3) at least one signal are further based, at least in part, on the following:
an encoding of device capability information, device contextual information, network information, or a combination thereof in the one or more transaction commands,
wherein the address information is determined based, at least in part, on the device capability information, the contextual information, the network information, or a combination thereof.

6. A method of claim 5, wherein the (1) data and/or (2) information and/or (3) at least one signal are further based, at least in part, on the following:
a processing of the address information to determine one or more resource hierarchies; and
a selection of the one or more resources from the one or more resource hierarchies based, at least in part, on the device capability information, the device contextual information, the network information, or a combination thereof.

7. An apparatus comprising:
at least one processor; and
at least one memory including computer program code for one or more programs,
the at least one memory and the computer program code configured to, with the at least one processor, cause the apparatus to perform at least the following,
determine one or more management operations for at least one device, one or more resources associated with the one or more management operations, or a combination thereof; and
process and/or facilitate a processing of the one or more management operations, the one or more resources, or a combination thereof to determine one or more transaction commands for completing the one or more management operations,
wherein the one or more transaction commands are realized, at least in part, via one or more request-response protocols.

8. An apparatus of claim 7, wherein the apparatus is further caused to:
cause, at least in part, an identification of the one or more management operations, the one or more resources, or a combination thereof in the one or more transaction commands using one or more resource identifiers.

9. An apparatus of claim 8, wherein the one or more request-response protocols includes, at least in part, a Hypertext Transport Protocol (HTTP); and wherein the one or more resource identifiers include, at least in part, one or more Uniform Resource Identifiers (URIs).

10. An apparatus of claim 7, wherein the apparatus is further caused to:
cause, at least in part, a transmission of the one or more transaction commands to at least one server according to the one or more request-response protocols; and
determine address information for the one or more management operations, the one or more resources, or a combination thereof in response to the transmission.

11. An apparatus of claim 10, wherein the apparatus is further caused to:
cause, at least in part, an encoding of device capability information, device contextual information, network information, or a combination thereof in the one or more transaction commands,
wherein the address information is determined based, at least in part, on the device capability information, the contextual information, the network information, or a combination thereof.

12. An apparatus of claim 11, wherein the apparatus is further caused to:
process and/or facilitate a processing of the address information to determine one or more resource hierarchies; and
cause, at least in part, a selection of the one or more resources from the one or more resource hierarchies based, at least in part, on the device capability information, the device contextual information, the network information, or a combination thereof.

13. A method comprising facilitating a processing of and/or processing (1) data and/or (2) information and/or (3) at least one signal, the (1) data and/or (2) information and/or (3) at least one signal based, at least in part, on the following:
a processing of one or more transaction commands from at least one device to determine one or more resources associated with one or more management operations;
a generation of one or more other resources associated with one or more management operations for the at least one device based, at least in part, on the one or more transaction commands; and
a transmission of address information associated with the one or more resources, the one or more other resources, or a combination thereof via one or more request-response protocols.

14. A method of claim 13, wherein the (1) data and/or (2) information and/or (3) at least one signal are further based, at least in part, on the following:
a processing of the one or more transaction commands to determine device capability information, device contextual information, network information, or a combination thereof;
a transmission of one or more responses to the at least one device based, at least in part, on the one or more transaction commands; and
one or more actions, one or more optimizations, or a combination thereof based, at least in part, on the one or more transaction commands.

15. A method of claim 14, wherein the (1) data and/or (2) information and/or (3) at least one signal are further based, at least in part, on the following:
a processing of the device capability information, the device contextual information, the network information, or a combination thereof to determine a status of the at least one device; and
a transmission of the address information based, at least in part, on the status.

16. A method of claim 14, wherein the (1) data and/or (2) information and/or (3) at least one signal are further based, at least in part, on the following:
a processing of the device capability information, the device contextual information, the network information, or a combination thereof to determine one or more resource hierarchies associated with the at least one device; and
a transmission of the address information based, at least in part, on the one or more resource hierarchies.

17. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more transaction commands from at least one device to determine one or more resources associated with one or more management operations;
cause, at least in part, a generation of one or more other resources associated with one or more management operations for the at least one device based, at least in part, on the one or more transaction commands; and
cause, at least in part, a transmission of address information associated with the one or more resources, the one or more other resources, or a combination thereof via one or more request-response protocols.

18. An apparatus of claim 17, wherein the apparatus is further caused to:
process and/or facilitate a processing of the one or more transaction commands to determine device capability information, device contextual information, network information, or a combination thereof;
cause, at least in part, a transmission of one or more responses to the at least one device based, at least in part, on the one or more transaction commands; and
cause, at least in part, one or more actions, one or more optimizations, or a combination thereof based, at least in part, on the one or more transaction commands.

19. An apparatus of claim 18, wherein the apparatus is further caused to:
process and/or facilitate a processing of the device capability information, the device contextual information, the network information, or a combination thereof to determine a status of the at least one device; and
cause, at least in part, a transmission of the address information based, at least in part, on the status.

20. An apparatus of claim 18, wherein the apparatus is further caused to:
process and/or facilitate a processing of the device capability information, the device contextual information, the network information, or a combination thereof to determine one or more resource hierarchies associated with the at least one device; and
cause, at least in part, a transmission of the address information based, at least in part, on the one or more resource hierarchies.
